(19) United States
(12) Patent Application Publication
(10) Pub. No.: US 2006/0250224 A1
(43) Pub. Date: Nov. 9, 2006

(54) Means of transport with a three-dimensional distance camera and method for the operation thereof

(75) Inventors: Hans-Clemens Steffel, Stuttgart (DE); Daniel Wagner, Weinsladt (DE); Dag Wagner, Palzen (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH, Esslingen (DE)

(21) Appl. No.: 10/543,910

(22) PCT Filed: Jan. 30, 2004
(86) PCT No.: PCT/DE04/00140

§ 371 Date: Jun. 22, 2006

(30) Foreign Application Priority Data
Jan. 30, 2003 (DE) 103 03 578.8

(51) Int. Cl. B60Q 1/00

(52) U.S. Cl. 340/435

(57) ABSTRACT

A hazard detection system for vehicles with at least one side and rear area sensing device, area interpretation device, and driver reaction assistance, wherein the area sensing device detects objects in motion which are moving relative to the vehicle carrying the hazard detection system. The hazard detection system has two sensors oriented opposite to the direction of travel. It includes at least one analysis and interpretation unit per sensor to determine geometry data and motion data of the sensed object. In addition, it has at least one display unit per sensor. Moreover, it has at least one information, control, and/or regulating unit acting on the vehicle brake system, vehicle steering system, and/or other vehicle assemblies, wherein said unit is influenced by the analysis and interpretation units.

The invention concerns a hazard detection system for vehicles with at least one side and rear area sensing device, area interpretation device, and driver reaction assistance, wherein the area sensing device detects objects in motion which are moving relative to the vehicle carrying the hazard detection system.

From DE 44 10 620 A1 is known a monitoring device for the driver and or passenger side of vehicles. The monitoring device comprises a sensor in the vehicle's exterior mirror for monitoring the blind spot region. The sensor, an ultrasonic or infrared sensor, is connected to a control unit that causes a visual signal to light up in the exterior mirror in the event that an object is detected in the blind spot in order to warn the driver. Object identification or predictive interpretation of motion is not possible here.

The present invention is thus intended to solve the problem of developing a hazard detection system for vehicles with at least one area sensing device that automatically detects present and impending hazardous situations and induces the driver who is not reacting soon enough to at least assess the situation visually.

This problem is solved by the features of the main claim. To this end, the hazard detection system has two sensors or sensor groups oriented opposite to the direction of travel or at an acute angle thereto, wherein said sensors or sensor groups are arranged at an offset to one another in the vehicle's lengthwise direction. The system includes at least one analysis and interpretation unit per sensor or sensor group to determine geometry data and motion data of the object or objects sensed. It has at least one display unit for each sensor or sensor group. In addition, it has at least one information, control, and/or regulating unit acting on the vehicle brake system, vehicle steering system, and/or other vehicle assemblies, wherein said unit is influenced by the analysis and interpretation units.

With the aid of the sensors affixed to the outside of the vehicle here, moving traffic, etc., in the blind spot region to the rear of the exterior mirror or mirrors is detected. By means of an analysis and interpretation unit, the images or contours detected by the sensors provide object characterization with respect to size or type, and the image sequences provide the relative motions of the object or objects observed. From the geometry and motion data, the analysis unit calculates a possible collision or near collision, in the event that the present courses of all objects involved are maintained. In both cases, the driver is warned by visual, acoustic, or tactile means, and if applicable is informed and/or prompted with respect to possible reactions to avert the danger.

Further details of the invention are evident from the dependent claims and the description below of schematically illustrated example embodiments.

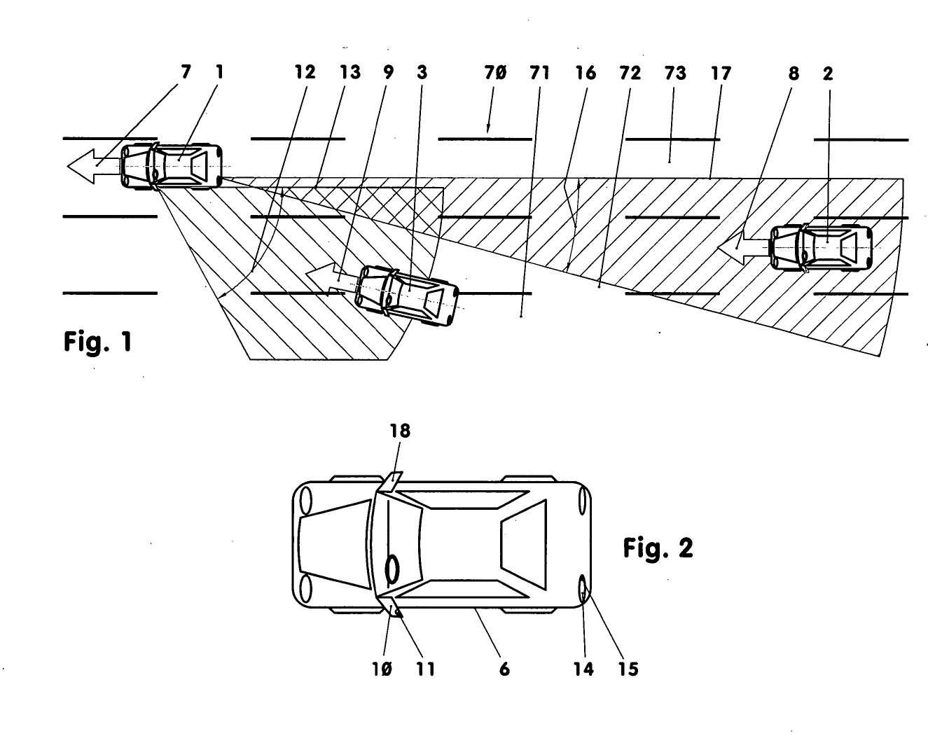

FIG. 1: Top view of vehicle with blind spot monitoring;

FIG. 2: Top view of vehicle;

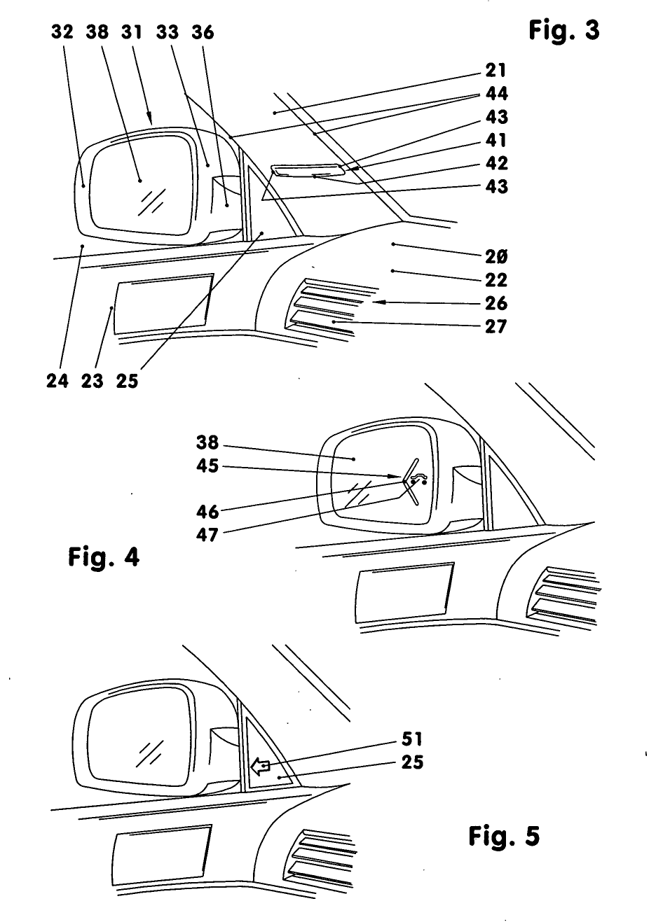

FIG. 3: Blind spot lamp in A-pillar;

FIG. 4: Blind spot lamp in mirror glass;

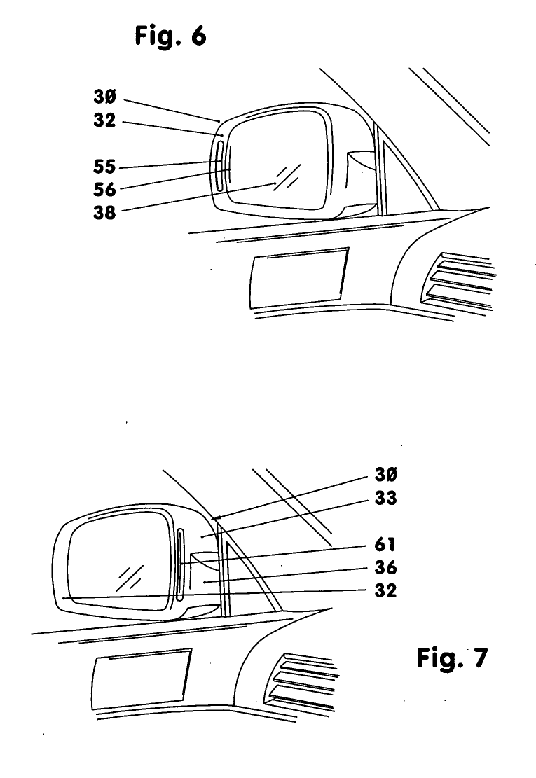

FIG. 5: Blind spot lamp in mirror triangle;

FIG. 6: Blind spot lamp in the inside mirror housing area;

FIG. 7: Blind spot lamp in the outside mirror housing area.

FIG. 1 shows a top view of a multi-lane road (70), for example, on which three vehicles (1, 2, 3) are driving in approximately the same direction (7, 8, 9). The first vehicle (1), the frontmost, has two sensors (11, 15) detecting the traffic to the rear, see also FIG. 2. The first sensor (11) is integrated in the exterior mirror (10) on the driver side, while the second sensor (15) is installed in the vehicle's rear area, e.g. in the driver-side rear light unit (14). If applicable, both exterior mirrors (10, 18) are also equipped with at least one sensor (11).

Alternatively, the sensor (11) located in the front, viewed in the direction of travel, can be accommodated in the exterior or interior mirror, on the mirror triangle for the outside mirror, on the third side directional signal, or in the grip strip of the driver-side door handle, among other locations. If the sensor (11) is integrated in a mirror, it can be located behind the mirror glass, on the mirror housing, or in the mirror base.

The mirror triangle is a region of the outer vehicle shell. It is generally part of the driver-side or passenger-side door and is located between the doorpost near the A-pillar and the door-side window. The mirror triangle carries and positions the exterior mirror on the driver or passenger door.

As an alternative to placement in the rear light unit (14), the rear sensor (15) can be positioned, for example, in the rear bumper, in the region of the tailgate handle, in the center auxiliary brake light, in the license plate light, or in a passenger compartment vent integrated in the C-pillar or D-pillar. Within the rear light unit (14), the sensor can be placed in the back-up light, in the turn signal light, in the taillight, in the rear fog light, or in the rear brake light.

The sensors (11, 15) can be digital cameras, range-finding cameras, laser systems or radar systems, for example. Motion sensors and other range measurement systems are also possible. Different sensor types can also be combined in a sensor group.

The front sensor (11) has an angle of view of approximately 60 to 80 degrees, with the line delimiting the field of view (13) nearest the vehicle extending along the outer contour of the vehicle body (6); in other words, this delimiting line (13) extends parallel to the direction of travel, for example. The detection and/or analysis range is 10 to 60 meters, for example.

The angle of view of the rear sensor (15) covers approximately 15 to 50 degrees, for example. The detection and/or analysis range extends to 30 to 40 meters, for example.

The purpose of the sensors (11, 15) is to sense the surroundings. They are meant to detect objects in motion, for example driving objects (2, 3), which move relative to the vehicle (1) in such a way that a later collision cannot be ruled out if the driver of vehicle (1) does not react by changing the direction of travel (7) or the speed. Through appropriate processing of the sensor data, the direction of motion, speed, and changes therein, are continuously calculated in an interpretation unit and compared with the comparable data for the vehicle (1). From these data are calculated a possible collision point or an encounter that is still collision-free but closer than a minimum distance. Both possibilities are interpreted as a hazardous situation.

Driver reaction assistance is derived from this. From the fact that vehicle direction (7) and speed are maintained, or from a change in one or both that increases a risk of collision, the hazard detection system interprets that the driver of (1) does not perceive the approaching object (2, 3) in the exterior mirror blind spot. In a first phase, the system forces the drive to look in the exterior mirror (10) by means of a lighted or blinking visual signal on or in the vicinity of the exterior mirror (10). Generally, the driver of (1), continuing not to perceive a hazard, will look back over his shoulder on the side facing the appropriate exterior mirror (10), notice the vehicle (2, 3) to the rear, and react appropriately to avert a danger.

Nearly any type of acoustic warning can assist the driver of (1) in this situation.

If the driver of (1) continues to evidence no reaction, in a second phase his attention is drawn to an imminent hazardous situation. Now the steering wheel and/or the brake or gas pedal serves as an information device. To this end, the steering wheel and/or the relevant pedal is set into a pulsing motion. As a rule, this pulsing motion has no direct effect on steering action or vehicle acceleration. Independently of this, if desired, the brake pressure is increased, for example, in order to shorten the braking response time.

Moreover, it is also possible for the system to activate the hot-air fan at a certain difference between the inside and outside temperatures and/or at or above a certain air humidity level in the interior air, and, by means of the ventilation grille (26), dry the side window, at least in the area of the exterior mirror, in order to improve visibility of the exterior mirror. Active adjustment of the ventilation louvers for optimal hot-air conduction is also possible.

The pulsing or vibrating motion of the steering wheel or at least one of the pedals makes the driver of (1), who has physical contact with at least the accelerator or steering wheel, expressly aware of a general or specific hazardous situation. For example, the vibration of the steering wheel can prepare him through tactile means for the need to avert the hazardous situation by turning the steering wheel. In addition or alternatively, in the case of a hazardous situation that turning the steering wheel would avert, the driver's seat can be palpably tilted in the direction in which the driver should steer. If desired, the seat and/or backrest can also vibrate in the process. In addition, instead of tilting of the seat—for example if it is necessary to steer toward the right—the left side of the driver's buttocks could be raised or the right side could be lowered. The palpable unilateral or alternating lifting can be in the range of millimeters.

The visual signal from the first warning phase is emitted by a light source in the form of a lamp (41-61). Such lamps are shown in FIGS. 3 through 7.

In addition, FIGS. 3-7 show the inside left corner of the passenger compartment (20). Visible is a part of the left-hand driver-side door (23), the part of the dashboard (22) located to the left of the steering wheel, the A-pillar (21), and an exterior mirror (30) located on a mirror triangle (25). Said mirror can be the exterior mirror (10) or (18)—shown in FIGS. 1 and 2—as suitable for a vehicle for driving on the left or the right.

In FIG. 3, a recess (42) is located in the interior paneling of the A-pillar (21); arranged in this recess is a blind spot lamp (41). The recess (42) extends, for example, primarily horizontally across the A-pillar paneling. The length of the lamp (41), measured horizontally, corresponds in this example to approximately 60% to 80% of the width of the A-pillar paneling at that location. The height of the, e.g., rhombus-shaped recess is approximately 10 millimeters, for example. The side borders (43) of the recess (42) or of the blind spot lamp (41) extend parallel to the nearest edges (44) of the A-pillar paneling, for example. The visible outside edge of the warning lamp (41) fitted into the recess is matched to the spatial curvature of the A-pillar paneling. In addition, the warning lamp (41) is domed slightly toward the passenger compartment (20) so that its center region projects slightly beyond the spatial curvature of the A-pillar paneling. The lamp lens of the blind spot lamp (41) has a red warning color, for example, similar to that of the emergency flasher button. If desired, the lamp lens in the inactivated state is the same color as the A-pillar paneling. Depending on the type of paneling, the lighting means, for example a light bulb or a light-emitting diode, can shine through the A-pillar paneling when activated.

In vehicles without A-pillar paneling, the blind spot lamp (41) sits directly in a recess worked in the hollow profile of the A-pillar (21).

FIG. 4 shows a blind spot lamp (45), which is integrated in the mirror glass (38) or located behind the partially at least semi-transparent mirror glass (38) in the mirror housing (31). Upon activation of the warning lamp (45), a stylized arrow (46) and a vehicle symbol (47) light up. The arrow (46) comprises two legs of equal length and equal width. The vertical height of the arrow (46) represents approximately 30% to 50% of the vertical extent of the mirror glass. The height of the triangle enclosed by the legs of the arrow is approximately 20% to 30% of the aforementioned extent of the arrow. The short height gives the driver the spatial impression that the arrow (46) is pointing into the blind spot region of the exterior mirror (30) as a warning. The vehicle symbol (47) between the arrow (46) and the edge of the mirror near the vehicle body consists of a bar with multiple bends and two rings beneath it. The bar represents the upper edge of an automobile silhouette in simplified form, while the two rings symbolize the vehicle wheels.

In FIG. 5, a blind spot lamp (51) in the shape of an arrow lamp pointing backward, which is to say opposite the direction of travel, is located in the mirror triangle (25). The length of the arrow (51) is, e.g., approximately 40-60% of the length of the mirror triangle measured in the direction of travel. The arrow height is approximately equal to the arrow length. The lamp lens of the arrow (51) projects approximately 1 to 2 millimeters beyond the surrounding surface of the mirror triangle (25), for example. With respect to the color, please refer to the description of FIGS. 3 and/or 4.

In FIGS. 6 and 7, the blind spot lamps (55) and (61) are likewise affixed outside the passenger compartment to the exterior mirror (30). Both warning lamps (55, 61) are oriented largely vertically in the mirror housing (31) in suitable recesses. Their length, measured in the vertical direction, is 5 to 10 times longer, for example, than their visible width.

As shown in FIG. 6, the warning lamp (55) is seated in the—for example—vertical section of the inner frame (32) of the mirror located farthest from the passenger compartment. The light from the activated warning lamp (55) is thus also reflected in the mirror glass (38), more strongly encouraging the driver to look in the exterior mirror (30).

The warning lamp (61) shown in FIG. 7 is located in the housing outer surface (33) of the mirror (30), facing the driver, between the housing inner frame (32) and the mirror-housing-side attachment of the mirror base (36).

The luminous intensity of the warning lamps (41-61) is adapted to the ambient brightness if desired, i.e. the brighter the environment, the more intensely the warning lamp (41-61) glows. The lamp lens material can be a transparent plastic, glass, or a comparable material. If desired, the lamp lens is simultaneously the body of the light source, e.g. the bulb of the incandescent lamp or the housing of an LED or LED array.

When both a right-side and a left-side hazard detection system are used, they can work together or can be independent of one another. Differences arising here can also be analyzed. The hazard detection system can be designed as a complete module that requires only very little vehicle data. Data exchange with the vehicle can take place over a LIN bus or CAN bus, for example. The module can be placed directly on or in the mirror housing, for example. Thus it can be permanently attached, for example, and also ensure good thermal transfer to the vehicle body.

The hazard detection system can also be used for the traffic space in front of the vehicle. If desired, the monitoring of the traffic space in front of the vehicle and behind the vehicle can be integrated in one module. Then, for example, pedestrians, traffic signs, special-purpose vehicles such as police, fire trucks, etc., can also be detected with the aid of the hazard detection system.

The warning indication can be provided by means of a lamp arranged on the edge of the driver's field of view. The warning then takes the form of flashing of the light, for example. The lamp, for example a light-emitting diode, can be directed at the driver.

The hazard detection system can include a brightness detection device, for example. Thus it can, e.g., switch over from a day mode to a night mode, possibly coupled to the on-board clock, and use the appropriate software program based on the mode. Also, in the event of, e.g., misadjustment of the hazard detection system, a warning message can be issued or the hazard detection system can automatically adjust itself or compensate for a misadjustment through the software. It is likewise possible for, e.g., the size and direction of the monitored region to be adjustable or settable by the driver, for example by means of an operating display. The hazard detection system can also be self-adjusting.

The type of warning message and if applicable the control signal issued by the hazard detection system can be governed by the severity of the danger. For example, they can be dependent on the travel speed of the monitoring vehicle, the travel speed of the monitored vehicle in the hazard zone, the radius of turn, etc.

The sensors (11, 15) can—as already mentioned—include an ordinary commercial camera and ordinary commercial optical lenses. These can then be arranged directly behind a window in a housing. The electrical components are then designed specifically for the hazard detection system, for example. The individual camera has a field of view of up to 60 degrees, for example. The lenses can have a hydrophilic or hydrophobic coating that is applied as a permanent coating, or is renewed during cleaning, for example.

The module can also be arranged in an area of the door that is subjected to moisture. The module can then be designed with IP 67 protection, for example. In this context, the wiring is in the sealed area, for example. Large-volume, sealed connectors can be eliminated. The lens and the CMOS electronics are then glued into the housing, for example.

The thermal expansions of the different device parts are compensated with a Gore Tex® seal, for example. This achieves, firstly, water tightness preventing the entry of moisture, and secondly prevents the build-up of an overpressure of air in the housing.

The software of the hazard detection system can be customer-specific. It can be programmed by the driver or the service shop, for example. It can be used for other applications in the vehicle in addition to the hazard detection system. For example, an interface to the data network of the vehicle can be provided. Thus, for example, the settings of the sensors (11, 15) can automatically be compensated depending on the loading of the vehicle (1). In addition, various operating states or driver-specific settings can be pre-programmed, for example based on the driver's specific field of view. In this regard, for example, it is possible to consider the seat position of the driver, the individual visual acuity of the driver, the reaction time of the driver, etc.

In order to protect the sensors (11, 15), they can be equipped with an electromechanically operated cover that is closed when the vehicle (1) is stopped. A cleaning mechanism for the lens, for example a wiper, spray nozzles, etc. is also possible.

The speed of the object (2, 3) relative to that of the vehicle (1) bearing the hazard [detection] system may be minimal. Thus, for example, even if two vehicles traveling at approximately the same speed should approach one another during a lane change, this can be detected. Conversely, even stopped vehicles can be detected.

The hazard detection system can also warn if there is and/or will be reduced visibility. This can be caused by, e.g., a dirty lens, fog, etc. In any event, the vehicle braking system, the vehicle steering system, and/or other vehicle assemblies can be influenced. To this end, the hazard detection system has infrared sensors in addition to sensors (11, 15) that detect objects (2, 3) in the visible spectrum, for example. These cited functions can also be combined in a single sensor (11, 15). The use of a night vision device in the hazard detection system or in combination therewith is also possible.

The CMOS electronics of the signal generator produces a black-and-white image, for example. The image produced can thus have a high pixel density.

As already mentioned, the warning signal can be visual, acoustic, tactile, etc. Combinations of these signals are also possible. The acoustic signals can be amplified through the audio system, for example. Thus, a stronger acoustic, visual, etc. signal can be issued depending on the degree of hazard. Different sequences of tones or sounds, verbal announcements, etc., are also possible. The visual warning signal in the mirror triangle (25), for example the blind spot lamp (51) designed in the shape of an arrow, is designed such that it elicits a glance at the mirror (10, 18). The warning signal alone thus does not provide complete information about the hazard and does not replace a look in the mirror (10, 18).

The hazard detection system can perform self-diagnostics with regard to its function. Thus, for example, it can regularly receive signals and report back over the data connection line from the vehicle (1). A special diagnostics interface is also possible.

The units can be used equally well for driving on the right or left.

The hazard detection system can monitor and recognize multiple vehicles (2, 3) simultaneously, and warn of possible hazards caused by these vehicles (2, 3). In this regard, for example, a closer vehicle (3) can be assessed as the primary danger and a vehicle (2) that is further away as a lesser danger.

The individual mirror (10, 18) can be attached by its base surface. In this way, it can be largely insensitive to vibrations, shocks, etc. In addition, the sensors (11, 15) can then be integrated in the base plate, for example. Adjustment of the mirror (10, 18) then does not affect the position of the sensors (11, 15). The sensors (11, 15) are then adjusted by means of an adjusting screw on the outside of the mirror (10, 18), for example.

The sensors (11, 15) can also be arranged in such locations as on the roof, in the doors, in the rear window, in the trunk lid, etc. Thus the detection regions (12, 16) can have a large overlap.

The hazard detection system can be used in the customary temperature range. Thus, even low temperatures and, for example, windows that are partly iced up, do not cause the hazard detection system to fail. In order to minimize the effects of extremely high or extremely low temperatures, the hazard detection system can also have protection against heat and/or cold, a heater, a fan, and/or a defroster for the lens. The individual components of the hazard detection system can also be electrically shielded. In this way, electrical influences on the hazard detection system by other vehicle components or electric and/or magnetic fields in the surroundings of the vehicle (1) can be prevented. In addition, the hazard detection system does not electrically and/or magnetically affect any other vehicle components or the environment.

The components of the hazard detection system can be arranged in a housing that is protected against unauthorized access. Thus, for example, it can be sealed or it can be closed with special screws. The housing can be made of die-cast aluminum with an anodic coating as corrosion-proofing, for example.

If a camera is used as a sensor (11, 15), the camera can include an auto focus, for example. The optics of the camera are then set such that objects in the more remote environment do not affect the sensors (11, 15), for example. The brightness information of the image recorded by the camera can be used to adjust the brightness of the warning lamp (41-61). The warning lamps (41-61) are arranged such that the driver can see them without turning his head, for instance.

In order to install the hazard detection system in a motor vehicle, the standard mirror can be replaced by a mirror (10, 18) that includes components of the hazard detection system, for example.

The images detected by the sensors (11, 15) and the information determined there from can be stored inside the vehicle (1), for example together with the operating parameters of the vehicle. In this way, an accident can be reconstructed after the fact. The data can also be transmitted to a removable storage medium. Even wireless transmission is possible, either in real time or at regular time intervals. The data can also already be compressed and processed at this point.

At least one of the sensors (11, 15) can also be arranged on a vehicle that is not self-propelled, such as a trailer, a semi trailer, etc. The towed vehicle is then connected to the data bus of the towing vehicle, if desired even over a wireless connection.

In the event of trailer operation, the hazard detection system can also sense yawing of the trailer, for example, before the trailer jackknifes relative to the towing vehicle.

The hazard detection system can also be connected to other systems assisting the driver, such as assistive braking, assistive lane changing, etc. In this regard, the hazard detection system can be adapted to the course of travel, for example. For instance, if the assistive lane changing system detects a lane change, the hazard detection system can monitor the danger zone accordingly. Also, the image from one or more cameras of the assistive lane changing system can be projected on the windshield together with the image from one or more cameras of the hazard detection system, for example. Then a complete image of the traffic space to the rear is presented on the so-called head-up display. If desired, the mirrors (10, 18) can be omitted entirely in this case. In this context, the hazard detection system is then connected to the internal data bus, for example by three wires, and connected to the head-up display by a two-wire line.

In hazard situations and on the highway, for example, the hazard detection system, if desired together with the other driver assistance systems, can supply data in order to influence, at least the steering of the vehicle.

The hazard detection system can also contain additional components, such as curb lights, mirror elements with controlled dimming and/or tint, heaters, etc. The data transmission and the control here can be accomplished through glass fibers, wireless transmission, etc. In addition, the hazard detection system can include an access control system, for example thermal profile monitoring for keyless access to the vehicle.

The sensors (11, 15) can be arranged separately from the analysis unit. The sensors (11, 15) can be placed at the top or bottom of the mirror (10, 18), for example. They are then connected to the analysis unit, which is located in the door, in the frame, on the inside of the door, the mirror triangle (25), etc.

It is possible to deactivate the hazard detection system. Thus, for example, it can be switched off for parking, to enter a garage, in traffic jams, in heavy traffic, etc. Switch-on and switch-off can be done automatically or by the driver.

### LIST OF REFERENCE CHARACTERS

1 vehicle with hazard detection system, automobile
2, 3 vehicles, automobiles, objects
6 vehicle body
7 direction of travel of (1)
8 direction of travel of (2)
9 direction of travel of (3)
10 exterior mirror of (1) with sensor
11 sensor in (10)
12 detection region of the sensor in (10)
13 line delimiting the field of view of (12)
14 rear light unit of (1) with sensor
15 sensor in (14)
16 detection region of the sensor in (14)
17 line delimiting the field of view of (16)
18 exterior mirror, passenger side
20 passenger compartment
21 A-pillar
22 dashboard
23 driver-side door
24 side window
25 mirror triangle
26 ventilation grille
27 ventilation louvers
30 exterior mirror
31 mirror housing
32 housing inner frame
33 housing outer surface
36 mirror base
38 mirror glass
41 blind spot lamp in the A-pillar, warning lamp
42 recess
43 side borders
44 edges of the A-pillar paneling
45 blind spot lamp in mirror glass, warning lamp
46 arrow symbol
47 vehicle symbol
52 blind spot lamp in mirror triangle, warning lamp
55 blind spot lamp in housing inner frame, warning lamp
56 reflection of the lamp light
61 blind spot lamp in the housing outer surface, warning lamp
70 road, three-lane
71 left lane
72 center lane
73 right lane

1. Hazard detection system for vehicles with at least one side and rear area sensing device, area interpretation device, and driver reaction assistance, wherein the area sensing device detects objects in motion which are moving relative to the vehicle carrying the hazard detection system, said hazard detection system comprising:
at least two sensors or sensor groups oriented opposite to the direction of travel or at an acute angle thereto, wherein said sensors or sensor groups are arranged at an offset to one another in the vehicle's lengthwise direction,
at least one analysis and interpretation unit per sensor or sensor group to determine geometry data and motion data of the object or objects sensed,
at least one display unit for each sensor or sensor group; and
at least one information, control, and/or regulating unit acting on the vehicle brake system, vehicle steering system, and/or other vehicle assemblies, wherein said unit is influenced by the analysis and interpretation units.

2. Hazard detection system according to claim 1, wherein the interpretation unit determines, from data acquired by at least one sensor of said two sensors or sensor groups, the direction of motion speed of motion, and changes therein, of the objects in motion moving relative to the vehicle.

3. Hazard detection system according to claim 2, wherein the interpretation unit of the vehicle uses the direction of motion, the speed of motion, and changes therein, and the motion data of the object or objects detected, to calculate a possible collision between the vehicle and at least one object.

4. Hazard detection system according to claim 1, wherein the interpretation unit classifies by type at least one object detected by said at least two sensors or sensor groups.

5. Hazard detection system according to claim 1, wherein, when a collision is calculated, the information unit causes the brake pedal of the vehicle to pulse, or initiates braking perceptible to the driver of the vehicle.

6. Hazard detection system according to claim 5, wherein the braking represents negative acceleration in the range of one tenth the gravitational acceleration.

7. Hazard detection system according to claim 1, wherein the information unit, when a collision is calculated, causes the steering wheel of the vehicle to pulse.

8. Hazard detection system according to claim 1, wherein the information unit includes at least one warning lamp that warns visually of an object arriving in or near the blind spot region of the vehicle exterior mirror, wherein the warning lamp is located on or in the vicinity of the exterior mirror in question.

9. Hazard detection system according to claim 8, wherein the warning lamp is a flashing lamp.

10. Hazard detection system according to claim 1, wherein the sensors include at least one camera.

11. Hazard detection system according to claim 1, wherein the analysis and interpretation unit can switch over at least from a day mode to a night mode as a function of the ambient brightness.

12. Hazard detection system according to claim 1, wherein the analysis and interpretation unit includes a data memory.

13. Hazard detection system according to claim 1, further including a data interface.

14. Hazard detection system according to claim 1, further including a self-diagnostics system.

15. Hazard detection system according to claim 1, wherein the control signal and/or warning signal issued by the analysis and interpretation unit depends upon the dynamic parameters of the monitoring vehicle and/or monitored vehicle.

16. Hazard detection system according to claim 1, wherein a warning signal is issued when visibility is bad and/or when visibility is worsening.

17. Hazard detection system according to claim 1, further comprising at least one sensor system oriented in the direction of travel.

18. Hazard detection system according to claim 1, further comprises a replacement for at least one mirror of the vehicle.

19. Hazard detection system according to claim 1, wherein it includes traffic sign detection.

20. Hazard detection system according to claim 1, further including a night vision device.
